(19) United States
(12) Patent Application Publication
(10) Pub. No.: US 2006/0050787 A1
(43) Pub. Date: Mar. 9, 2006

(54) Method and/or apparatus for encoding and/or decoding digital video together with an n-bit alpha plane

(75) Inventor: Lowell L. Winger, Waterloo (CA)

Correspondence Address: LSI LOGIC CORPORATION, 1621 BARBER LANE, MS: D-106, MILPITAS, CA, 95035, US

(73) Assignee: LSI LOGIC CORPORATION

(21) Appl. No.: 10/935,351

(22) Filed: Sep. 7, 2004

(51) Int. Cl. H04N 7/12; H04N 11/04; H04B 1/66; H04N 11/02

(52) U.S. Cl. 375/240.12

(57) ABSTRACT

A method for generating a compressed digital video bitstream, comprising the steps of receiving a first subsequence representing a video signal, receiving a second sub-sequence representing an alpha signal, and generating the compressed digital video bitstream in response to the first sub-sequence and the second sub-sequence. The compressed digital video bitstream (i) includes information from said video signal and information from said alpha signal and (ii) conforms to a defined transmission standard.

### FIELD OF THE INVENTION

The present invention relates to a digital video generally and, more particularly, to a method and/or apparatus for encoding and/or decoding digital video together with an n-bit alpha plane.

### BACKGROUND OF THE INVENTION

An alpha component (sometimes referred to as matte or key) may be considered a fourth color component of a pixel. An alpha component specifies the degree of opacity, translucency, or transparency of a pixel. An alpha component is typically used to control color blending, and is frequently treated as a separate output signal in video systems.

Alpha channels are used in many professional production environments. For example, SMPTE (the Society of Motion Picture and Television Engineers) defines a dual-channel HD-SDI (high definition serial data interface) and SD-SDI (standard definition serial data interface) for uncompressed carriage/transmission. SMPTE also defines a S268M standard for uncompressed file storage.

Referring to FIG. 1, a system 10 illustrates such a conventional approach to video and alpha storage/transmission. A video signal is presented to an encoder 12. The encoder 12 presents a compressed bitstream to a storage or decoder device 14. An alpha component is presented to an alpha decoder 14. The alpha decoder 14 presents a grayscale bitstream to a storage or decoder device 18. Since separate bitstreams are encoded and stored, duplicate storage and decode devices 14 and 18 and duplicate encoders 12 and 16 are needed.

Many commonly used standards for digital video compression (e.g., H.262, H.263, MPEG-2) do not provide explicit support for encoding an N-bit (e.g., 8, 10, or 12-bit) alpha plane. The H.264 standard has been amended to include explicit support (e.g., in the fidelity range extensions (FRExt)) for alpha together with video. Using current solutions other than H.264, applications that implement the transmission and/or storage of alpha channel information together with compressed image sequences have typically encoded the alpha information as a separate luminance-only (grayscale) bitstream and/or file. While the H.264 FRExt extensions provide support for alpha and video together, a device needs to be compliant with every aspect of the standard to be certified.

In general, encoding alpha as a separate channel and/or file is inconvenient and needs two separate bitstreams or two separate files to represent the combined signal. From a practical implementation, additional resources are duplicated in the handling of these streams (e.g., two decoders are needed for decompressing the bitstreams and two encoders are needed for encoding the bitstreams). Also, synchronization and maintenance of timing information between alpha and video signals presents additional difficulties.

It would be desirable to implement a system for encoding digital video together with a n-bit alpha plane that does not rely on the H.264 FRExt extensions.

### SUMMARY OF THE INVENTION

The present invention concerns a method for generating a compressed digital video bitstream, comprising the steps of receiving a first subsequence representing a video signal, receiving a second sub-sequence representing an alpha signal, and generating the compressed digital video bitstream in response to the first sub-sequence and the second sub-sequence. The compressed digital video bitstream (i) includes information from said video signal and information from said alpha signal and (ii) conforms to a defined transmission standard.

The objects, features and advantages of the present invention include providing a method and/or apparatus for encoding digital video that may (i) include an N-bit alpha plane, (ii) be implemented without duplicating encoding/decoding hardware, and/or (iii) be compliant with one or more of the amended versions of the H.264 standard.

### BRIEF DESCRIPTION OF THE DRAWINGS

These and other objects, features and advantages of the present invention will be apparent from the following detailed description and the appended claims and drawings in which:

FIG. 1 is a block diagram of a conventional alpha component encoding system;

FIG. 2 is a block diagram of a preferred embodiment of the present invention; and

FIG. 3 is a diagram illustrating a number of video frames along with a number of alpha frames.

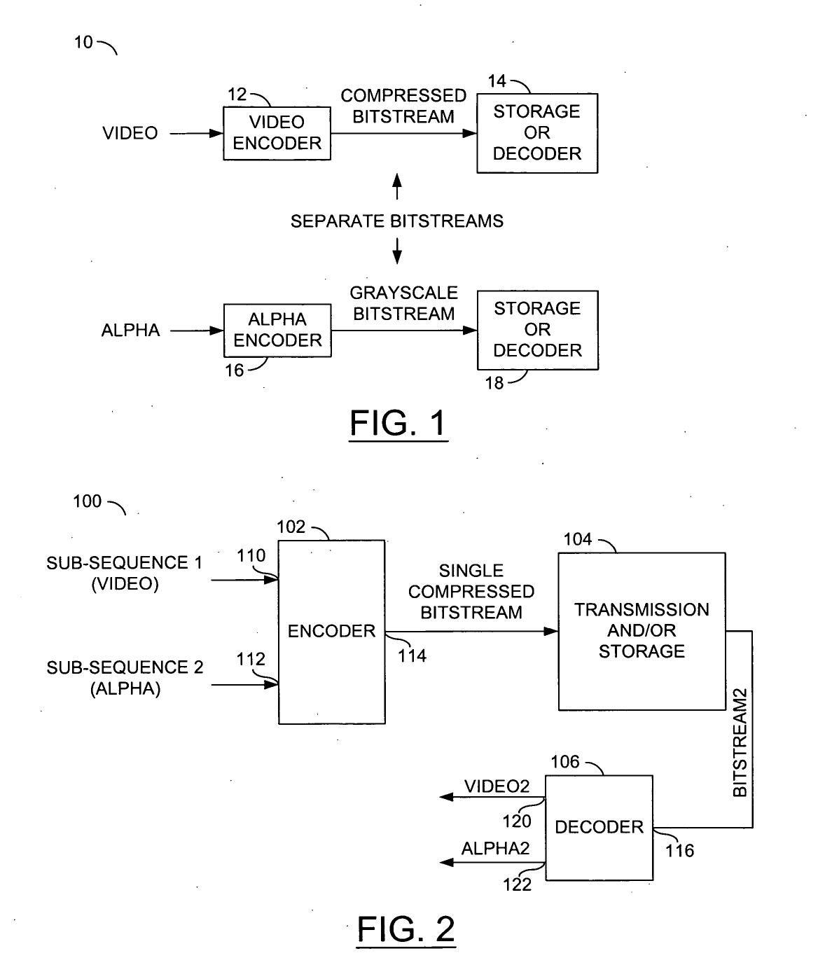

### DETAILED DESCRIPTION OF THE PREFERRED EMBODIMENTS

Referring to FIG. 2, a block diagram of a system 100 is shown in accordance with a preferred embodiment of the present invention. The system 100 generally comprises an encoder 102, a transmission and/or storage medium 104 and a decoder 106. The encoder may have an input 110 that may receive a signal (e.g., VIDEO) and an input 112 that may receive a signal (e.g., ALPHA). The signal VIDEO may be an uncompressed video signal. The signal ALPHA may represent the degree of opacity, translucency or transparency of each pixel of the signal VIDEO. The encoder 102 may have an output 114 that presents a signal (e.g., BITSTREAM). The signal BITSTREAM may be a compressed bitstream. The signal BITSTREAM may include both video information from the signal VIDEO and alpha information from the signal ALPHA. The signal BITSTREAM is presented to the transmission and/or storage medium 104.

If the signal BITSTREAM is intended to be transmitted (e.g., through a cable television network, a satellite transmission system, an over-the-air transmission system, etc.) then the block 104 is implemented as a transmission medium. If the signal BITSTREAM is intended to be stored for future playback (e.g., in a digital video recorder, a network television production facility, etc.), then the block 104 may be implemented as a storage medium. The storage medium may be implemented in a variety of ways, such as with one or more hard disc drives, one or more optical disc drives, etc. In either a transmission and/or a storage configuration, the block 104 presents a signal (e.g., BITSTREAM2) to an input 116 of a decoder 106. The signal BITSTREAM2 is similar to the signal BITSTREAM and contains video information from the signal VIDEO and alpha information from the signal ALPHA. The decoder 106 may have an output 120 that presents a signal (e.g., VIDEO2) and an output 122 that presents a signal (e.g., ALPHA2). The signal VIDEO2 and the signal ALPHA2 are reproductions of the signal VIDEO and the signal ALPHA. The signals VIDEO2 and ALPHA2 may be either lossy or lossless reproductions of the signals VIDEO and ALPHA, depending on the mode of transmission implemented.

The recently standardized international video coding standards ISO/IEC 14496-10:2003/IS (AVC) and ITU-T Rec. H.264, have been amended with “Fidelity Range Extensions.” The new amendments (ISO/IEC 14496-10 Amd1, and ITU-T Rec. H.264/AVC (Fidelity Range Extensions Amendment)) to these standards include (i) support for 4:2:2, 4:4:4, and grayscale colorspaces and (ii) support for 10-bit and 12-bit pixel depths (in addition to the previously supported 4:2:0 8-bit video).

Both the amended and the original non-amended standard explicitly support independent sub-sequences to be contained within a single bitstream and/or file. It is understood that these sub-sequences in the standard explicitly support temporal and computational scalability (e.g., through temporal subsampling of the decoding process) in compressed video. A note in the standard indicates that subjective quality is expected to increase along with the number of decoded layers. It is also understood that sub-sequences may be useful for trick-modes (e.g., increased decoding/playback rate), to support multitasking and parallel implementations of encoders and decoders (e.g., parallelism at the frame level), and to support increased flexibility in transcoding and transrating (through identifying which sub-sequences may be manipulated independently). The present invention uses the syntax available for supporting subsequences to accommodate the video and alpha components as a single bitstream. The compressed video signal may be one subsequence (e.g., SUB1) and the alpha component may be another subsequence (e.g., SUB2). In addition to implementing the sub-sequences as SUB1 and SUB2, the present invention may also implement several additional elements in order to combine alpha and video in a single bitstream.

The present invention proposes using the mechanisms provided for subsequence support to combine a compressed video signal and associated alpha channel together into a single compressed channel. The present invention uses the syntax provided in the amended and extended MPEG-AVC/H.264 standards.

In particular, individual subsequences are identified with unique IDs in the AVC/H264 syntax. The additional information may be conveyed either implicitly or explicitly to identify which subsequence(s) convey video and which subsequence(s) convey the associated alpha information. This may take the form of an externally specified convention (e.g,. a custom SEI “supplemental enhancement information” message), or may be inferred implicitly (according to a convention). For example, a convention may be developed where alpha would be represented as a grayscale sub-sequence, while video would be represented in a color format. However, the particular convention used may be varied to meet the design criteria of a particular implementation. Alternatively, reserved, unspecified, and/or newly defined values for bitstream syntax elements may be used to explicitly signal the presence of both video and alpha sub-sequences.

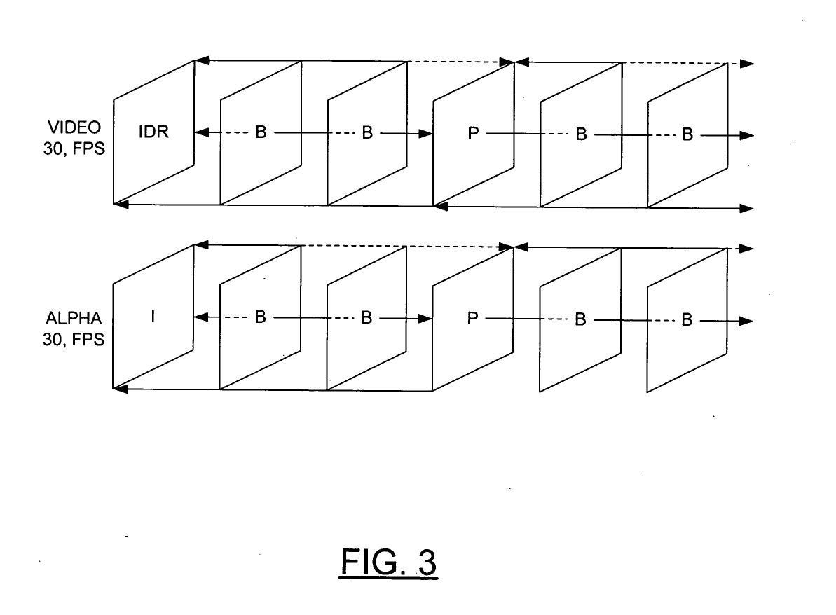

Two independent sub-sequences SUB1 and SUB2 are specified, one for video and one for alpha, respectively. A grayscale alpha sub-sequence and a color video sub-sequence would be represented as independent sub-sequences in the sub-sequence data dependency hierarchy (e.g., there should not be any inter-prediction between these two sub-sequences). FIG. 3 illustrates a number of frames for the signal VIDEO and the signal ALPHA. The frames are shown from left to right in an increasing output order. The arrows above each signal represent independent motion compensation.

One possible convention that may be used is to implement the display and/or output timing information associated with an individual frame of video to indicate which grayscale frame of the signal ALPHA is associate with each particular frame of the signal VIDEO. A mechanism may be implemented for ensuring the correct association of a particular video frame with an associated alpha component. There may be advantages in terms of buffering (e.g., the HRD “Hypothetical Reference Decoder” model that is specified in the standard) if the convention chosen permits the encoder 102 to flexibly specify the output times of the alpha and video. For example, the convention may select an alpha frame to be constrained to always follow immediately after (in output order) an associated video frame. A display time would conventionally be held to be identical to that specified for an associated video frame (rather than any other display time information that might otherwise be independently associated with the alpha frame). The exact timing of the output may then be calculated by the encoder 102 to take best advantage of the specified capabilities of the HRD for the profile and at the level of the bitstream being encoded.

The present invention may provide a combined compressed representation of video and associated alpha within a single bitstream by using the capabilities of the H.264/AVC standard (which enables the representation of two (or more) independently coded sub-sequences within a single bitstream).

The present invention may constrain the alpha and video only such that they may be contained within the same bitstream permitting a great deal of flexibility and independent control over the alpha and video in many significant respects. For example, the present invention may allow the use of a different bitdepth for alpha and video, although typically alpha would have at least as many bits as the video. Further, the present invention explicitly permits the capability to vary the fidelity of the alpha relative to the fidelity of the video, a desirable feature for many applications. In general, fidelity of the signal VIDEO and the signal ALPHA may refer to an associated bit depth and color resolution (in addition to the particular bitrate and/or quantizer values used). In addition, the present invention may also explicitly permit independent motion compensation and mode-decision for alpha and the video, another desirable feature, as alpha may acts quite differently than video.

As long as a bitstream containing the combined alpha and video sub-sequences conforms to the requirements of H.264/AVC for a specified profile and at a specified level (regarding bitrates, buffersizes, etc.) the combined signals may be decoded or encoded with only a single device that supports a single compressed bitstream. Additional timing and/or synchronization will not normally be needed beyond what is already provided by the H.264/AVC standards within the syntax of the single bitstream.

Display issues are not specified in the H.264 standard. Input and output of video transmitted along with alpha may use additional capability beyond that provided by a device that does not support alpha. However, the present invention will be compatible with any device that has been verified to be capable of the encoding and/or decoding tasks used by the standard. Such compatible devices (without any modification) will normally be capable of the encoding and/or decoding tasks needed for video plus alpha.

By combining video and alpha into a single bitstream, editing, splicing, commercial insertion, statmuxing and many other processes may be greatly simplified. The present invention may enable the potential for significant system simplicity and cost benefits over the existing solution.

It should be understood that video coding formats other than H.264/MPEG-AVC that provide sufficient flexibility to represent at least two independently decodable subsequences, one color (for video), and the other grayscale (for alpha) within a single bitstream may provide an appropriate way to implementing invention.

While the invention has been particularly shown and described with reference to the preferred embodiments thereof, it will be understood by those skilled in the art that various changes in form and details may be made without departing from the spirit and scope of the invention.

1. A method for generating a compressed digital video bitstream, comprising the steps of:
(A) receiving a first subsequence representing a video signal;
(B) receiving a second sub-sequence representing an alpha signal; and
(C) generating said compressed digital video bitstream in response to said first sub-sequence and said second sub-sequence, wherein said compressed digital video bitstream (i) includes information from said video signal and information from said alpha signal and (ii) conforms to a defined transmission standard.

2. The method according to claim 1, wherein said method is implemented in a video encoder/decoder.

3. The method according to claim 1, wherein said video information and said alpha information are implemented without inter-prediction.

4. The method according to claim 1, wherein said method provides independent motion compensation between the video signal and the alpha signal.

5. The method according to claim 1, wherein said method provides independent fidelity compensation between said video signal and said alpha signal.

6. The method according to claim 1, wherein said compressed digital video signal contains sufficient timing information for decoding.

7. An apparatus for generating a compressed digital video bitstream, comprising:
means for receiving a first subsequence representing a video signal;
means for receiving a second sub-sequence representing an alpha signal; and
means for generating said compressed digital video bitstream in response to said first sub-sequence and said second sub-sequence, wherein said compressed digital video bitstream (i) includes information from said video signal and information from said alpha signal and (ii) conforms to a defined transmission standard.

8. The apparatus according to claim 7, wherein said apparatus is implemented in a video encoder/decoder.

9. An apparatus comprising:
a first input configured to receive a first subsequence representing a video signal;
a second input configured to receive a second subsequence representing an alpha signal; and
an output configured to generate a compressed digital video bitstream in response to said first sub-sequence and said second sub-sequence, wherein said compressed digital video bitstream (i) includes information from said video signal and information from said alpha signal and (ii) conforms to a defined transmission standard.

10. The apparatus according to claim 9, wherein said apparatus is implemented in a video encoder/decoder.

11. The apparatus according to claim 9, wherein said apparatus provides independent motion compensation between the video signal and the alpha signal.

12. The apparatus according to claim 9, wherein said apparatus provides independent fidelity compensation between said video signal and said alpha signal.
